(19) United States
(12) Patent Application Publication
(10) Pub. No.: US 2023/0390994 A1
(43) Pub. Date: Dec. 7, 2023

(54) BIOEXTRUDER ASSEMBLY

(71) Applicant: 3D SYSTEMS, INC., ROCK HILL, SC (US)

(72) Inventors: Ricardo SOLORZANO, ROCK HILL, SC (US); Nicholas MCKNIGHT, ROCK HILL, SC (US)

(73) Assignee: 3D SYSTEMS, INC., ROCK HILL, SC (US)

(21) Appl. No.: 18/034,259

(22) PCT Filed: Jul. 19, 2021
(86) PCT No.: PCT/US2021/042147

§ 371 Date: Apr. 27, 2023

Related U.S. Application Data
(60) Provisional application No. 63/053,000, filed on Jul. 17, 2020.

(51) Int. Cl. B29C 64/106; B29C 64/209

(52) U.S. Cl. CPC B29C 64/106; B33Y 10/00; B29C 64/209

(57) ABSTRACT

Disclosed is a bioextruder assembly capable of “retro-fit” an existing three-dimensional (3D) printer such that it is capable of printing biomaterials. The bioextruder assembly may be modular, self-contained, and configured as “plug-and-play” unit. In some embodiments, the bioextruder assembly may be configured for use in zero-gravity environments such as space and configured to engage with existing 3D printers in space. In some embodiments the bioextruder assembly includes an extruder configured to extrude bio-materials stored in a syringe that is coupled to the extruder, and a converter. The converter may include an electromechanical coupling component that couples the converter to a three-dimensional printer system, and a motor configured to actuate the extrusion of bio-materials stored in the syringe based on signals received from the three-dimensional printing system via the electromechanical coupling component. In some embodiments, the converter may be configured to reversibly attach to the extruder via an attachment element.

### CROSS REFERENCE TO RELATED APPLICATIONS

The present disclosure is related to and claims the benefit of U.S. Provisional Application No. 63/053,000, entitled “Bioextruder Assembly,” the contents of which is hereby incorporated by reference, in its entirety.

Additionally, the contents of both U.S. application Ser. No. 15/128,632 entitled “Methods, devices, and systems for the fabrication of materials and tissues utilizing electromagnetic radiation,” and U.S. application Ser. No. 15/945,435 entitled “Multi-headed auto-calibrating bioprinter with heads that heat, cool, and crosslink,” are hereby incorporated by reference, in their entirety.

### TECHNICAL FIELD

The present disclosure is directed towards device capable of printing three-dimensional (3D) biological structures.

### BACKGROUND

Three-dimensional (3D) printers have been used to print biological tissue, organs and the like. However, installing new 3D printers capable of printing biological structures may be difficult in many environments.

For example, although it may be advantageous to be able to print biological structures in space due to zero-gravity, at present the international space station is not equipped with a 3D printer capable of printing biological structures. Further, it would be difficult to install a new 3D printer capable of printing biological structures in space.

### SUMMARY

The present disclosure describes a bioextruder assembly that may be used to retrofit an existing three-dimensional (3D) printer such that it is capable of printing biomaterials. The bioextruder assembly may be modular, self-contained, and be configured as “plug-and-play” unit. The bioextruder assembly may be configured to engage with existing 3D printers.

In some embodiments, the bioextruder assembly may be configured for use in zero-gravity environments such as space.

In some embodiments, a bioextruder assembly includes an extruder and a converter. The extruder may be configured to extrude bio-materials stored in syringe that is coupled to the extruder. The converter may include an electromechanical coupling to a three-dimensional printer system, and a motor configured to actuate the extrusion of bio-materials stored in the syringe based on one or more signals received from the three-dimensional printing system via the electromechanical coupling. Further, the converter may be configured to reversibly attach to the extruder via an attachment interface.

In some embodiments, the disclosed converter may be used to allow extruders of various manufacturers to interface with three-dimensional printing systems produced by other manufacturers.

In some embodiments, a bioextruder assembly may include an extruder configured to extrude bio-materials stored in syringe, wherein the syringe is coupled to the extruder, and a converter having an electromechanical coupling component that couples the converter to a three-dimensional printer system, and a motor configured to actuate the extrusion of bio-materials stored in the syringe based on one or more signals received from the three-dimensional printing system via the electromechanical coupling component. In some embodiments, the converter may be configured to reversibly attach to the extruder via an attachment element. The attachment element may include one or more magnetic pins. Alternatively, the attachment element may include a first end spaced apart from a second end, the first end configured to engage with a screw of the motor, and the second end having a cutout configured to engage with a top end of the syringe. In some embodiments, the attachment element includes a plunger configured to compress a spring along a strike plate of the converter. In some embodiments the electromechanical coupling component transmits at least one of the one or more signals received from the three-dimensional printing system, power, and extruder status between the three-dimensional printing system and the extruder. The converter may include a metal rod configured to engage with the extruder. The extruder may be configured to generate a pressure using at least one of a piston, compressed gas, hydraulics, air compressor, piezo-electronics, and inkjet dispensing extrusions. The extruder may also include a light emitting diode configured to emit electromagnetic radiation having a wavelength greater than or equal to 405 nanometers. The converter may be configured to electromechanically interface with a plurality of three-dimensional printers.

In some embodiments, a method of bioprinting may include the steps of loading bio-materials into a syringe, inserting the syringe into an extruder, engaging an extruder with a converter electromechanically coupled to a three-dimensional printer, receiving a print plan for the extruder from the three-dimensional printing system at a motor of the extruder, and extruding the contents of the syringe in accordance with the received print plan. Engaging the extruder with the converter may include engaging a spring latch mechanism by connecting an attachment element of the converter to the syringe. In some embodiments, the print plan may be generated based on commands received from the three-dimensional printing system and data corresponding to the extruder-converter assembly. In some embodiments, engaging the extruder with the converter includes engaging a magnetic connection between the extruder and the converter.

In some embodiments, a converter includes an electromechanical coupling component that couples the converter to a three-dimensional printer system, a motor configured to actuate the extrusion of bio-materials stored in a syringe based on one or more signals received from the three-dimensional printing system via the electromechanical coupling component, and an attachment element configured to reversibly attach the converter to an extruder having the syringe. In some embodiments the attachment element includes one or more magnetic pins. The attachment element may include a first end spaced apart from a second end, the first end configured to engage with a screw of a motor of an extruder, and the second end having a cutout configured to engage with a top end of a syringe on the extruder. The attachment element may also include a plunger configured to compress a spring along a strike plate of the converter. The electromechanical coupling component may be configured to transmit at least one of the one or more signals received from the three-dimensional printing system, power, and extruder status between the three-dimensional printing system and an extruder engaged with the converter. In some embodiments the converter includes at least one of a metal rod configured to engage with the extruder and a metal strike plate. In some embodiments the converter is configured to electromechanically interface with a plurality of three-dimensional printers.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A illustrates an extruder in accordance with some embodiments of the present disclosure.

FIG. 1B illustrates an extruder and a syringe in accordance with some embodiments of the present disclosure.

FIG. 1C illustrates an extruder and a syringe in accordance with some embodiments of the present disclosure.

FIG. 1D illustrates an extruder and a converter in accordance with some embodiments of the present disclosure.

FIG. 1E illustrates an extruder and a converter assembly in accordance with some embodiments of the present disclosure.

FIG. 1F illustrates an extruder and a converter assembly in accordance with some embodiments of the present disclosure.

FIG. 2 illustrates an attachment element, in accordance with embodiments of present disclosure.

FIG. 3A illustrates an extruder and converter assembly in a first state in accordance with some embodiments of the present disclosure.

FIG. 3B illustrates an extruder and converter assembly in a second state in accordance with some embodiments of the present disclosure.

FIG. 4 illustrates components of an extruder and converter assembly in accordance with some embodiments of the present disclosure.

FIG. 5A illustrates components of an extruder and converter assembly in accordance with some embodiments of the present disclosure.

FIG. 5B illustrates a converter element in accordance with some embodiments of the present disclosure.

FIG. 6A illustrates an attachment element for an extruder, in accordance with embodiments of present disclosure.

FIG. 6B illustrates an attachment element for a converter, in accordance with embodiments of present disclosure.

FIG. 7 illustrates an example of a first printed material in accordance with an embodiment of the present disclosure.

FIG. 8 illustrates an example of a second printed material in accordance with an embodiment of the present disclosure.

### DETAILED DESCRIPTION

The present disclosure is directed towards systems and methods associated with a three-dimensional bioprinting. “Bioprinting” or “printing” as used herein may refer to a three-dimensional, precise deposition of cells and/or other substances and materials using an automated, computer-aided three-dimensional prototype device (e.g., a bioprinter). The present disclosure is directed towards an extruder assembly that is capable over converting an existing 3D printer into a bioprinter.

Bioprinters and their related components such as printer stages, receiving means, cartridges, dispensing means, extrusion means, electromagnetic radiation (EMR) source, optical device, software, and the like are described further in U.S. application Ser. No. 15/128,632 entitled “Methods, devices, and systems for the fabrication of materials and tissues utilizing electromagnetic radiation,” and U.S. application Ser. No. 15/945,435 entitled “Multi-headed auto-calibrating bioprinter with heads that heat, cool, and crosslink,” the contents of both of which are hereby incorporated by reference, in their entirety.

The present disclosure describes a bioextruder assembly that may be used to “retro-fit” an existing three-dimensional (3D) printer such that it is capable of printing biomaterials. For example, the bioextruder assembly may be used to retrofit a 3D printer capable of printing only plastic materials. The bioextruder assembly may be modular, self-contained, and be configured as “plug-and-play” unit. In some embodiments, the bioextruder assembly may be configured for use in zero-gravity environments such as space and be configured to engage with existing 3D printers in space.

It may be desirable to print biomaterials in space in order to study the impacts of gravity on biological structures and perform scientific experiments. For example, the ability to print biomaterials in space may allow scientists and engineers to better understand how bones would grow and tissues would organize if there was no gravity.

In some embodiments, a bioextruder assembly includes an extruder and a converter. The extruder may be configured to extrude bio-materials stored in syringe that is coupled to the extruder. The converter may include an electromechanical coupling to a three-dimensional printer system, and a motor configured to actuate the extrusion of bio-materials stored in the syringe based on one or more signals received from the three-dimensional printing system via the electromechanical coupling. Further, the converter may be configured to reversibly attach to the extruder via an attachment interface.

In some embodiments, the disclosed systems and methods may be configured to allow an already existing bioprinter or 3D printer to adapt to bioprinting using a new biomaterial extruder. For example, a unique extruder may become compatible with a bioprinter that has either different electronic configuration or software configurations. Example extruders may include cells or biomaterials, or any combination thereof

Example printers may include traditional three-dimensional printers, bioprinters that are from different manufacturers, three-dimensional bioprinters and the like.

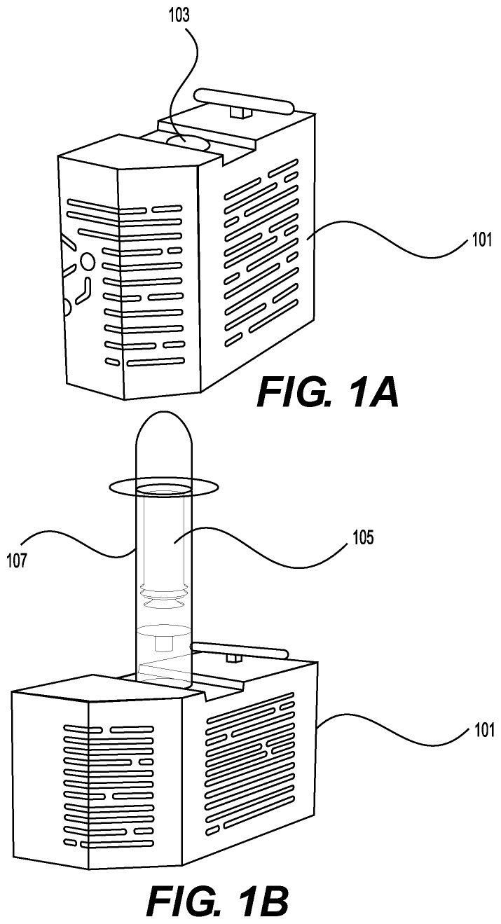

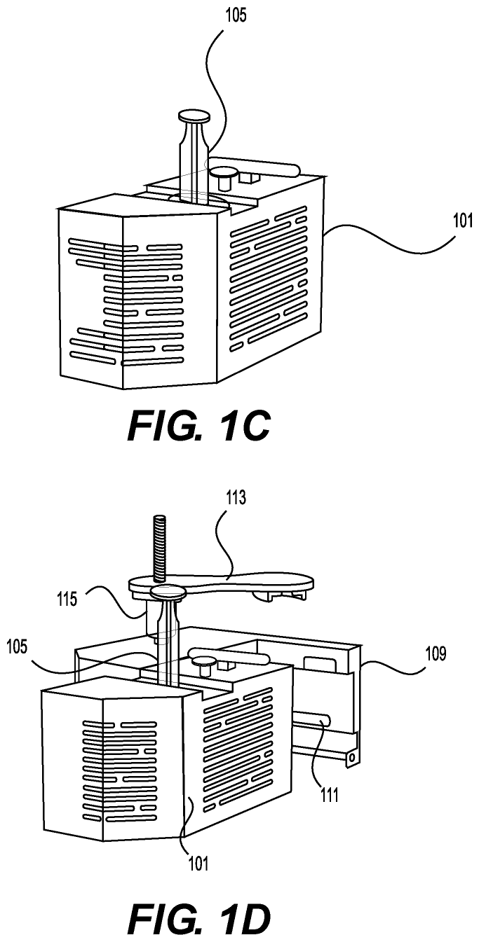

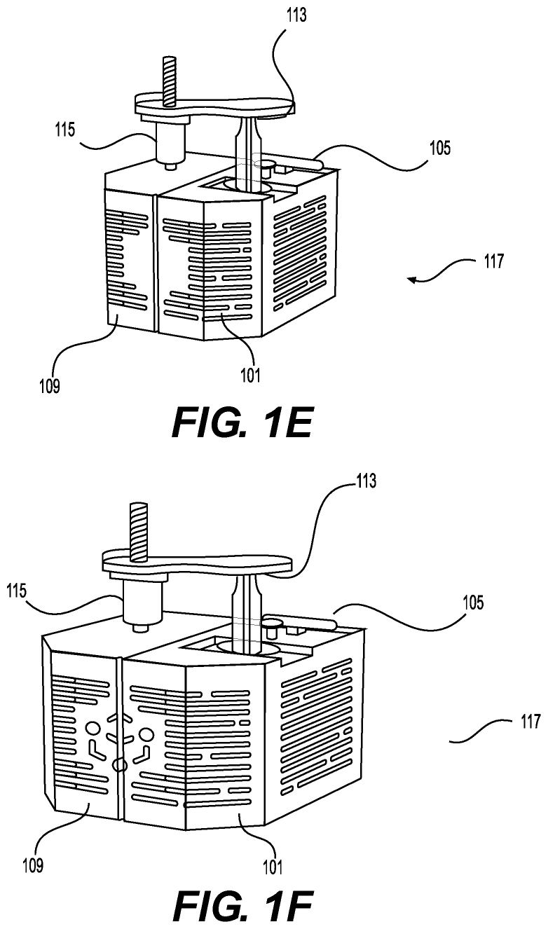

FIGS. 1A-1F illustrate extruders 101, syringes 105, and/or converters 109 in accordance with an embodiment of the present disclosure. An extruder 101 may be configured to extrude and cure biomaterials in accordance with techniques for bioprinting. Extruders may include one or more extruder heads, heating and/or cooling elements, LED lights configured to cure printed objects and an opening configured to receive a syringe, and/or materials for bio-printing. In some embodiments, the syringe and/or materials for bio-printing may be removable from the extruder assembly.

As illustrated in FIG. 1A, an extruder 101 may include an opening 103 configured to receive a syringe. In some embodiments, the extruder 101 may be pre-loaded with a syringe having bio-materials, without requiring a user of the bioextruder assembly to have to load a syringe with bio-materials. In this manner, the bioextruder assembly may be a “plug-and-play” system.

In some embodiments, the extruder 101 may include a plurality of extruder heads, each configured to heat or cool the biomaterials. For example, in some embodiments, the extruder 101 may be configured to heat materials to 160 degrees Celsius, and then cool the materials to 4 degrees Celsius when curing.

Additionally, the extruder 101 may be configured with a light emitting diode (LED) positioned at the bottom of the extruder 101 that is configured to cure materials 107 extruded from the extruder 101 by applying a suitable wavelength. In some embodiments, the suitable wavelength may be 365 nm or 405 nm. In some embodiments, visible blue light may be used to cure biomaterials rapidly without damaging cells.

In some embodiments, the extruder 101 can heat between room temperature to 400 degrees Celsius, cool between room temperature to −10 degrees Celsius, or use UV or light waves in the visible spectrum to dispense and cross link materials 107.

In some embodiments, the extruder 101 may be configured for use on a space station. In some embodiments, the extruder 101 may be configured to be mounted to a converter 109 to form an extruder-converter assembly 117 that can interface with a 3D printer of any type. For example, the 3D printer may be located on the international space station or other space stations. For example, the extruder may be configured to interface with a three-dimensional printer made by another manufacturer.

As illustrated in FIG. 1B, the syringe 105 may include one or more materials 107 configured to be bioprinted. Example materials 107 may include hydrogels, or biocompatible pastes that are mixed with or without biological cells. Alternatively, the materials 107 may be cells, growth factors, and/or cytokines. Materials 107 may be one or more of the following: hydrogels, Gelatin Methacrylate (GelMA), Pluronic® F-127, Polyethylene glycol diacrylate (PEGDA), Collagen, Collagen Methacrylate (CMA), Fibrin, Hyaluronic Acid, Growth Factors (e.g., vascular endothelial growth factor (VEGF)), Cyropreservative additives to preserve the cells during flight (e.g., sugars), living cells (i.e., human, plant or animal cells), and the like. In some embodiments, the materials 107 (or extruder 101, syringe 105, and/or converter 109) may be shipped in a cryopreserved container to preserve the materials 107 and protect them from the stresses experienced during shipping the materials 107 to the space station.

As illustrated in FIG. 1C, the syringe 105 may be loaded into the extruder 101. In some embodiments, the extruder 101 may be provided to a user of the bioextruder assembly with the syringe 105 preloaded into the extruder 101.

FIG. 1D illustrates an extruder 101 and a converter 109 in accordance with an embodiment of the present disclosure. The converter 109 may include a housing 109 containing a motor that drives a piston 115. The piston 115 may be configured to drive the motion of the syringe 105 contained within the extruder 101. In particular, the piston 115 may actuate the plunger of the syringe 105. In some embodiments, the system may utilize at least one of compressed air, inkjet, or piezo electrics to drive the dispension of the material 107 out of the extruder. In this manner, the piston 115 may control the extrusion of the materials 107.

The converter 109 may also include an attachment element 113 that is driven by the piston 115 and is configured to attach to the syringe 105. In some embodiments, the attachment element 113 may include a metal adapter. In some embodiments, the attachment element 113 may be configured to be able to rotate 360 degrees.

Further, the converter 109 may include an attachment interface 111 that is configured to engage the converter 109 with the extruder 101. In some embodiments the attachment interface 111 may include one or more clips, tracks, locks, and the like, such that the converter and extruder may slideably engage and lock together to form an extruder-converter assembly 117 such as that depicted in FIG. 1E. Although a slideable attachment interface 111 is described herein, any suitable attachment interface is possible. In some embodiments the attachment interface 111 may include click-on rail connectors.

The converter 109 may include an electromechanical coupling component (e.g., a Controller Area Network (CAN) bus) that couples the converter 109 to a 3D printer system. The electromechanical coupling component may allow for the exchange of power, and data between the converter 109 and the 3D printer system. In some embodiments, the electromechanical coupling component may receive one or more signals from the 3D printer system that are configured to control the operation of the motor of the converter 109 and actuate the extrusion of the materials 107 stored in the syringe 105.

After the converter 109 is attached to the extruder 101, by way of the attachment interface 111, the attachment element 113 may be configured to engage with the syringe 105.

The extruder-converter assembly 117 may then be placed within a three-dimensional (3D) printer (e.g., MadeInSpace's Additive Manufacturing Facility (AMF)).

The extruder-converter assembly 117 may be attached to a foreign printer, a 3D printer that was not originally configured to be used with the extruder. For example, the converter may interface with a foreign printer that allows for the exchange of power, data, and extrusion stepping via electrical outputs. In some embodiments, the converter may interface with a foreign printer by mechanical means such as magnet with locating pins, a spring latch mechanism, or the like.

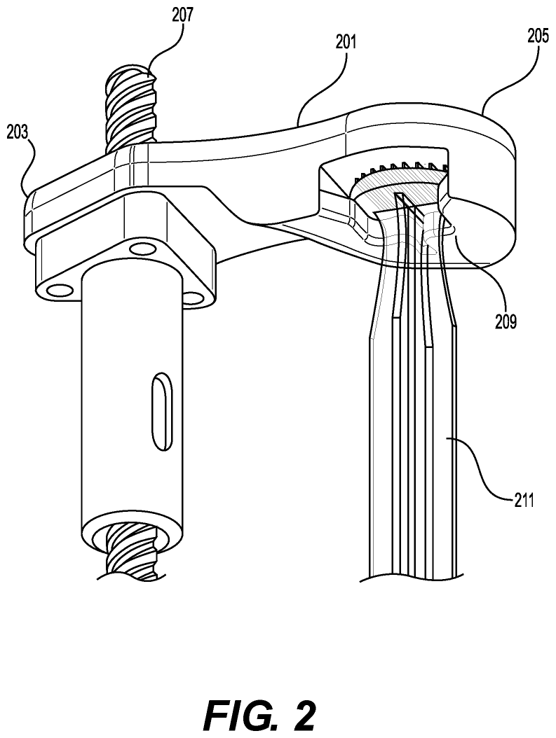

FIG. 2 provides an illustration of an example attachment element and attachment interface such as attachment element 113 and attachment interface 111 of FIG. 1. For example, in some embodiments, the attachment element 201 may be composed of 6061 Aluminum. In another embodiment, the attachment element 201 may be composed of durable plastic. One side 203 of the attachment element 201 may be configured to attach to the nut of the lead screw 207 on the extrusion motor. On the other side 205 of the attachment element 201, it may be configured to have a cutout slot 209 that is configured to engage with a syringe plunger flange 211. The cutout slot 209 may be further configured to fix the plunger 211 in place with respect to the vertical axis and constrain rotation of the syringe. Accordingly, activation of the motor will move the attachment element 201 and plunger 211 downwards.

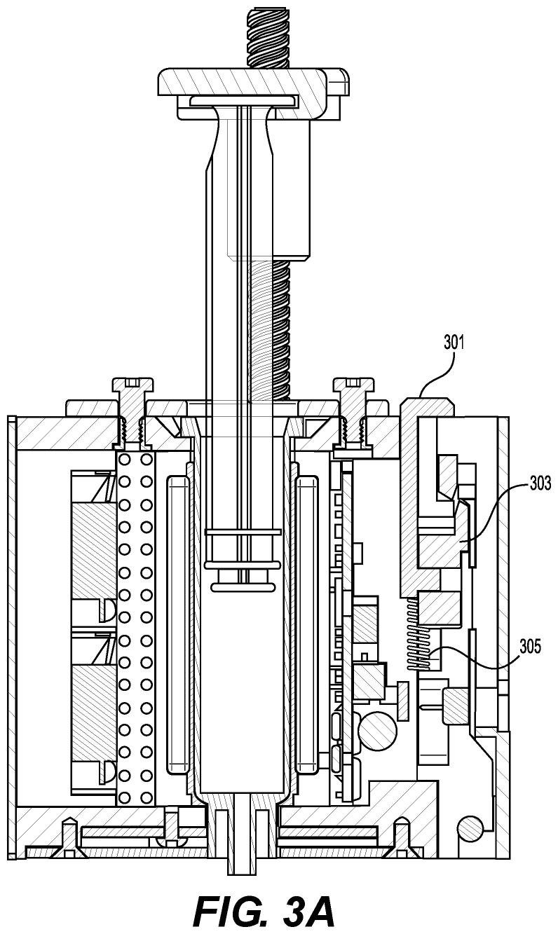

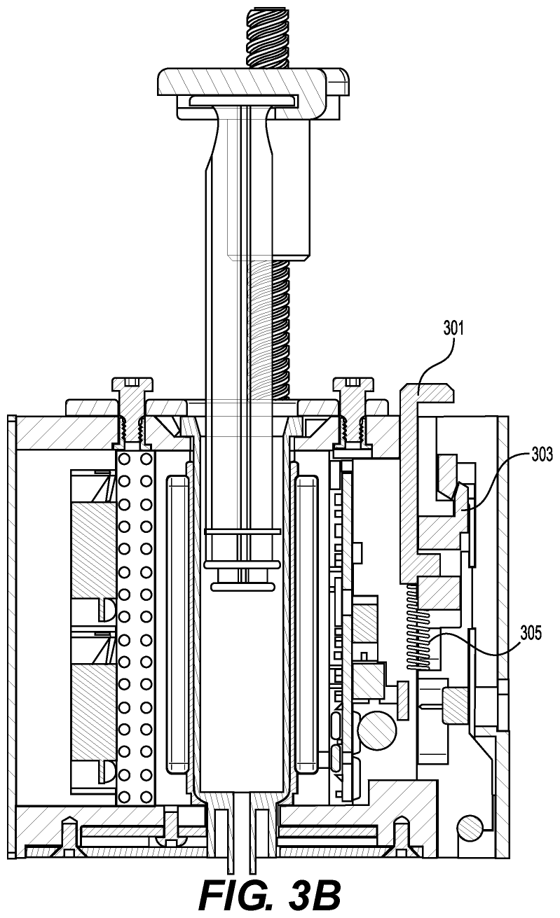

FIGS. 3A and 3B provide cross-sectional views of the assembly. For example, FIG. 3A illustrates when the converter and extruder are disengaged. FIG. 3B illustrates when the converter and extruder are engaged. In particular, as illustrated in FIG. 3A when a plunger 301 is depressed, the plunger 301 may push a latch 303 against a spring 305 to compress the spring thus allowing the latch to move vertically downwards past a brass strike plate. In some embodiments, the plunger may include a metal tab. In some embodiments, the latch 303 may be composed of brass. In some embodiments, the strike plate may be attached to the back piece of the converter. When the plunger 301 is released, the spring 305 may be biased to extend thus pushing the latch 303 up behind the strike plate, which results in the engagement of the latch 303 and securing the extruder assembly to the converter, as is illustrated in FIG. 3B.

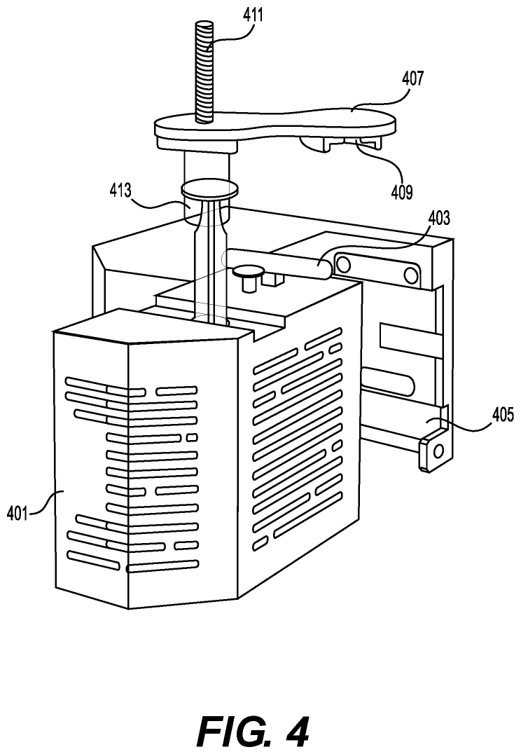

FIG. 4 provides a second illustration of the assembly discussed herein. As illustrated, an extruder 401 is in a separated state from a converter 405. A plunger 403 analogous to plunger 301 of FIG. 3 is illustrated. The extruder 401 includes a syringe 413 configured to hold biomaterials. A top end of the syringe 413 is configured to engage with a cutout 409 of the attachment element 407, analogous to that illustrated in FIG. 3. As shown, the second end of the attachment element 407 is proximate a screw of the extrusion motor 411.

To engage the extruder 401 with the converter 405, the plunger 403 may be pressed down to disengage the latch. A groove on the back-bottom of the extruder 401 may be aligned with a horizontal metal rod positioned on the converter 405.

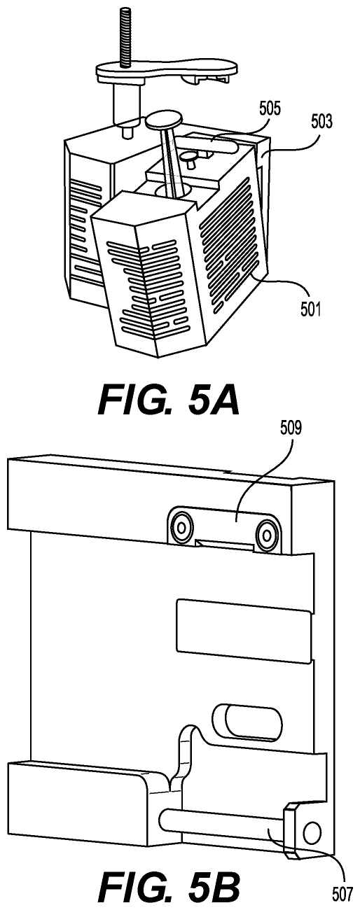

FIGS. 5A and 5B provide additional illustration of the extruder and converter assembly. In particular FIG. 5A illustrates the rotation of the extruder 501 away from the converter 503 and towards a user of the device. To secure the extruder 501 to the converter 503 a plunger 505 may be pushed in a substantially downward direction in order to disengage the latch. A groove on the back-bottom of the extruder 501 may be aligned with a horizontal metal rod 507 on the converter 503 and push the extruder 501 so the back face of the extruder is parallel with the interior face of the converter 503. When aligned, the plunger may be released to allow the spring (illustrated in FIGS. 3A and 3B) to push up the plunger and engage the latch with the strike plate on the interior of the back piece of the converter 503. The described process results in the extruder 501 and the converter 503 being secured together. To release the extruder 501 from the converter 503, the plunger may be pressed down to disengage the latch. As illustrated in FIG. 5A, the extruder 501 may be rotated and/or pulled in a direction substantially towards the user, thus enabling the extruder to pivot on the horizontal rod 507 and releasing the extruder from the extruder-converter assembly.

FIG. 5B provides an illustration of the interior of the converter 503 back piece with the rod 507 and brass strike plate 509.

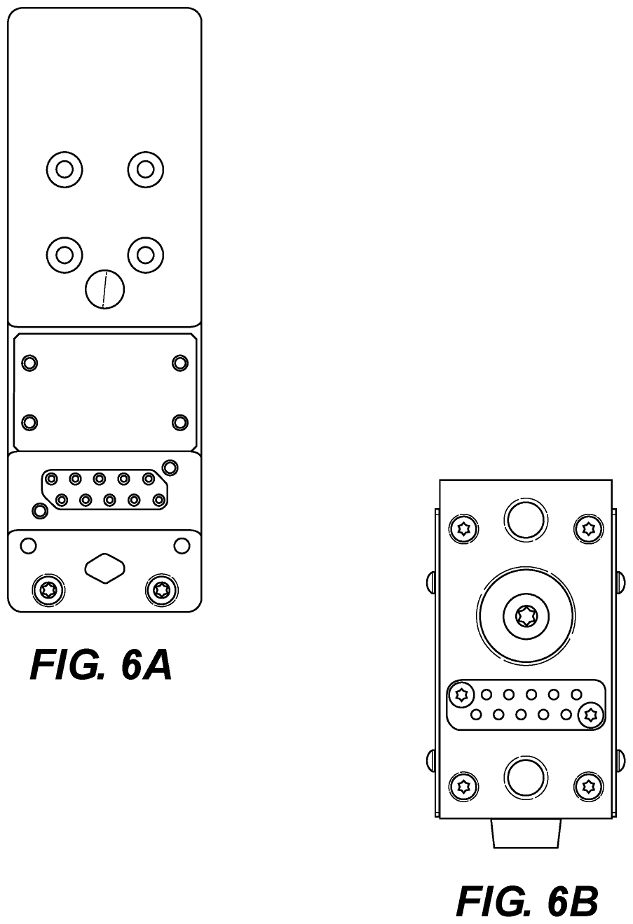

An alternative mechanism for attaching an extruder to a converter is illustrated in FIGS. 6A and 6B. For example, the attachment mechanism between the extruder 601 and the converter 603 may include a magnetic interface. In some embodiments, the magnetic interface may include, for example, two alignment pins configured for alignment (e.g., one round shaped pin, one diamond shaped pin). In some embodiments, the alignment pins may be composed of metal. In some embodiments, the alignment pins could be located on the back piece of the converter 603 and the extruder 601 may have corresponding hemispherical cutouts at those mating locations. FIG. 6A illustrates an example of the converter interface, and FIG. 6B illustrates an example of the interface on the extruder.

As described herein, an extruder may be connected to a connector configured to attach the extruder-connector assembly to a foreign printer. Data that may be exchanged from the foreign printer to the attached extruder include CAN protocol messages that set temperature setpoints and crosslinking intensities, exchange temperature feedback, and the like. The extruder-connector assembly may interface with the foreign printer using an electrical interface. In some embodiments, the electrical interface may include spring loaded pogo pins that transmit power and data. A user of the foreign printer may control extrusion of bio-materials using the extrusion. For example, a user may control extrusion of the bio-materials using the original interface of the foreign printer, including by specifying a print path or distance the extrusion motor may travel in order to move a certain volume of material. The original interface of the foreign printer may include a graphical user interface configured to receive instructions from a user of the foreign printer and create and send custom gcode commands and print files to the foreign printer in order to control operation of the foreign printer. The print files and related commands provided by the foreign printer may be modified for compatibility with the extruder-connector assembly. For example, commands may be modified to allow for a modified extrusion rate and temperature ranges. For example, while gcode files are read into the device, the received print files may need to be post-processed to function with the add-on printing device to handle crosslinking functionality and to convert the volume per motor step of the extrusion motor.

The systems and methods described herein may be used to attach a non-compatible extruder to a printer. In some embodiments, materials for printing such as bio-materials and the like may be loaded into a syringe, and then inserted into an extruder. A plunger and stopper may be utilized to attach the extruder with a connector using a spring latch mechanism. In a next step the attachment element may be connected to the syringe plunger flange. In a subsequent step, a needle may be attached to the bottom of the syringe. The printer may then be activated, with appropriate parameters for the temperature and crosslinking elements set, and the print surface calibrated. The post-processed gcode file may then be loaded onto the printer, and the print may be run.

Various constructs and patterns can be printed out using the extruder-converter assembly described herein with or without cells. For example, bioprinting material can be extruded in zero gravity to be able to print either biomaterials or cell laden hydrogels in a 3D printed pattern.

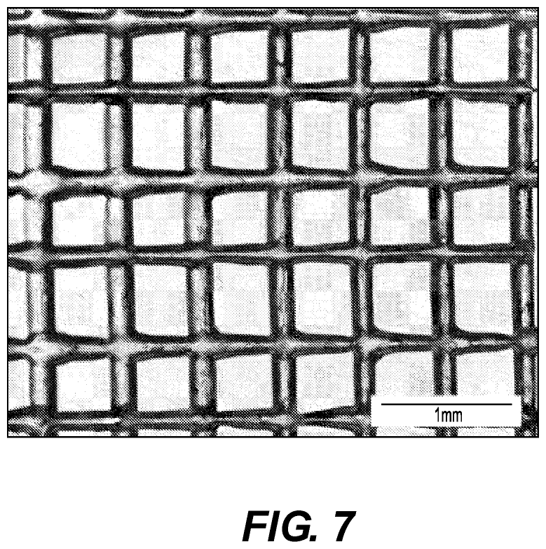

For example, FIG. 7 illustrates an example of a first printed material in accordance with an embodiment of the present disclosure. In particular, FIG. 7 illustrates a lattice bioprinted from pluronic.

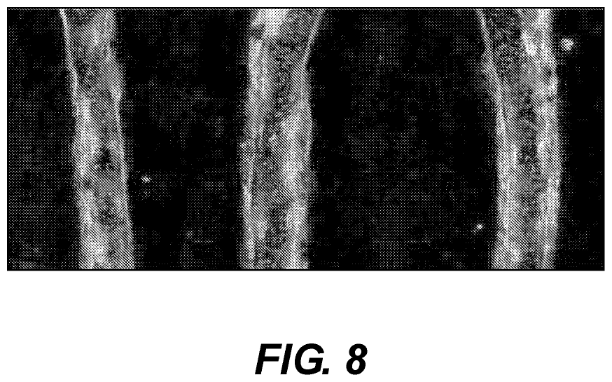

FIG. 8 illustrates an example of a second printed material in accordance with an embodiment of the present disclosure. In particular, FIG. 8 illustrates lines printed with Gelatin Methacrylate using encapsulated fibroblasts.

Example materials that may be printed by the systems and methods described above include bone, striated fibers, liver tissue, layered tissues, circular patches, vascularized tissues, heart tissue, cartilage, and the like. In some embodiments, the printed materials may form shapes under zero-gravity conditions that are useful for scientific applications.

Although the present disclosure may provide a sequence of steps, it is understood that in some embodiments, additional steps may be added, described steps may be omitted, and the like. Additionally, the described sequence of steps may be performed in any suitable order.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

We claim:

1. A bioextruder assembly comprising:
an extruder configured to extrude bio-materials stored in a syringe, wherein the syringe is coupled to the extruder; and
a converter comprising:
an electromechanical coupling component that couples the converter to a three-dimensional printer system, and
a motor configured to actuate the extrusion of bio-materials stored in the syringe based on one or more signals received from the three-dimensional printing system via the electromechanical coupling component,
wherein the converter is configured to reversibly attach to the extruder via an attachment element.

2. The bioextruder assembly of claim 1, wherein the attachment element comprises one or more magnetic pins.

3. The bioextruder assembly of claim 1, wherein the attachment element comprises a first end spaced apart from a second end, the first end configured to engage with a screw of the motor, and the second end having a cutout configured to engage with a top end of the syringe.

4. The bioextruder assembly of claim 3, wherein the attachment element comprises a plunger configured to compress a spring along a strike plate of the converter.

5. The bioextruder assembly of claim 1, wherein the electromechanical coupling component transmits at least one of the one or more signals received from the three-dimensional printing system, power, and extruder status between the three-dimensional printing system and the extruder.

6. The bioextruder assembly of claim 1, wherein the converter comprises a metal rod configured to engage with the extruder.

7. The bioextruder assembly of claim 1, wherein the extruder is configured to generate a pressure using at least one of a piston, compressed gas, hydraulics, air compressor, piezo-electronics, and inkjet dispensing extrusions.

8. The bioextruder assembly of claim 1, wherein the extruder further comprises a light emitting diode configured to emit electromagnetic radiation having a wavelength greater than or equal to 405 nanometers.

9. The bioextruder assembly of claim 1, wherein the converter is configured to electromechanically interface with a plurality of three-dimensional printers.

10. A method of bioprinting comprising:
loading bio-materials into a syringe;
inserting the syringe into an extruder;
engaging an extruder with a converter electromechanically coupled to a three-dimensional printer;
receiving a print plan for the extruder from the three-dimensional printing system at a motor of the extruder; and
extruding the contents of the syringe in accordance with the received print plan.

11. The method of claim 10 wherein engaging the extruder with the converter comprises engaging a spring latch mechanism by connecting an attachment element of the converter to the syringe.

12. The method of claim 10, wherein the print plan is generated based on commands received from the three-dimensional printing system and data corresponding to the extruder-converter assembly.

13. The method of claim 10 wherein engaging the extruder with the converter comprises engaging a magnetic connection between the extruder and the converter.

14. A converter comprising:
an electromechanical coupling component that couples the converter to a three-dimensional printer system,
a motor configured to actuate the extrusion of bio-materials stored in a syringe based on one or more signals received from the three-dimensional printing system via the electromechanical coupling component; and
an attachment element configured to reversibly attach the converter to an extruder having the syringe.

15. The converter of claim 14, wherein the attachment element comprises one or more magnetic pins.

16. The converter of claim 14, wherein the attachment element comprises a first end spaced apart from a second end, the first end configured to engage with a screw of a motor of an extruder, and the second end having a cutout configured to engage with a top end of a syringe on the extruder.

17. The converter of claim 14, wherein the attachment element comprises a plunger configured to compress a spring along a strike plate of the converter.

18. The converter of claim 14, wherein the electromechanical coupling component transmits at least one of the one or more signals received from the three-dimensional printing system, power, and extruder status between the three-dimensional printing system and an extruder engaged with the converter.

19. The converter of claim 14 comprising at least one of a metal rod configured to engage with the extruder and a metal strike plate.

20. The converter of claim 14, wherein the converter is configured to electromechanically interface with a plurality of three-dimensional printers.
